(19) United States
(12) Patent Application Publication
(10) Pub. No.: US 2006/0282614 A1
(43) Pub. Date: Dec. 14, 2006

(54) OPTICAL DISC DRIVE FOR ACCESSING BLU-RAY DISC AND DECODER THEREOF

(76) Inventors: Jia-Horng SHIEH, Taipei Hsien (TW); Li-Lien Lin, Hsin-Chu City (TW); Jyh-Shin Pan, Hsin-Chu County (TW)

Correspondence Address: NORTH AMERICA INTELLECTUAL PROPERTY CORPORATION, P.O. BOX 506, MERRIFIELD, VA, 22116, US

(21) Appl. No.: 11/420,800

(22) Filed: May 29, 2006

(30) Foreign Application Priority Data
Jun. 10, 2005 (TW) 094119175

(51) Int. Cl. G06F 13/00

(52) U.S. Cl. 711/111

(57) ABSTRACT

An optical disc drive includes a pickup head, a DSP coupled to the pickup head, a buffer memory, a decoder coupled to the DSP and the buffer memory, and a control unit coupled to the decoder. The pickup head reads data stored in a blu-ray disc to generate an electrical signal. The DSP receives the electrical signal from the pickup head, and generates an LDC block and a BIS block according to the electrical signal. The decoder receives the LDC block and the BIS block from the DSP, generates user data and control data according to the LDC block and the BIS block respectively, and stores the user data and the control data into the buffer memory. The control unit controls the operation of the decoder.

### BACKGROUND

The embodiments relate to optical disc drives, and more particularly, to optical disc drives for accessing blu-ray discs and decoders thereof.

Blu-ray discs are a kind of storage medium that have a large storage capacity. For example, a single layer blu-ray disc can store up to 27 GB of data. FIG. 1 shows the data format of blu-ray discs. User data that is going to be stored in a blu-ray disc is divided into a plurality of frames, where each of the frames has 2048+4 bytes. Every 32 frames constitute a block 108 shown in FIG. 1. The block 108 is allocated to become a data block 106 having 304 columns×216 rows. Adding the data block 106 with 32 rows of parity forms a long distance code (LDC) block having 304 columns×248 rows. The LDC block 106 is then allocated to become an error correction code (ECC) cluster having 152 columns×496 rows.

Similarly, a block 118 having 32×18 bytes of logical address and control data is combined with a block 120 having 16×9 bytes of physical address to form an access block 116 having 24 columns×30 rows. Adding the access block 116 with 32 rows of parity forms a burst indicator sub-code (BIS) block having 24 columns×62 rows. The BIS block 114 is then allocated to become a BIS cluster having 3 columns×496 rows.

After the ECC cluster 102 and the BIS cluster 112 are formed, data included in these two clusters are arranged alternately to form a block 100, which is referred to as a physical cluster block 100. The physical cluster block 100 comprises a sync section, four ECC sections, and three BIS sections.

FIG. 2 shows an optical disc drive of the related art capable of accessing blu-ray discs. The optical disc drive 200 shown in FIG. 2 comprises a pickup head 210, a digital signal processor (DSP) 220, a buffer memory 230, a decoder 240, a BIS processing unit 250, and a control microprocessor 260. The pickup head 210 reads data stored in a blu-ray disc to generate an electrical signal and sends the electrical signal to the DSP 220. The DSP 220 processes the received electrical signal to generate LDC blocks and BIS blocks, and sends the LDC blocks and the BIS blocks to the decoder 240 and the BIS processing unit 250 respectively. In this example the buffer memory 230 is implemented by a random access memory (RAM), which provides memory space to the decoder 240. The control microprocessor 260 controls the operation of the decoder 240.

The decoder 240 comprises a DSP interface 241, an LDC processing unit 247, and a host interface 249. The DSP interface 241 receives the LDC blocks from the DSP 220 and stores the LDC blocks into the buffer memory 230. In addition, the DSP interface 241 also examines the received LDC blocks to generate a synchronization signal, so that the start position of the LDC blocks or the BIS blocks can be determined accordingly.

The LDC processing unit 247 fetches the LDC blocks, which are stored by the DSP interface 241, from the buffer memory 230, processes (e.g. error corrects) the LDC blocks to generate resulting user data, and stores the user data into the buffer memory 230. The host interface 249 fetches the user data, which is stored by the LDC processing unit 247, from the buffer memory 230 and sends the user data to a host device (not shown in FIG. 2).

The BIS processing unit 250 receives the BIS blocks from the DSP 220, processes (e.g. error corrects) the BIS blocks to generate resulting control data, and sends the control data to the control microprocessor 260. As well as controlling the operation of the decoder 240, the control microprocessor 260 is further responsible for transmitting the control data. Therefore, the data throughput of the control microprocessor 260 constitutes a factor that limits the accessing speed on the blu-ray disc.

### SUMMARY

The embodiments disclose an optical disc drive for accessing a blu-ray disc. The optical disc drive comprises: a pickup head for reading data stored in the blu-ray disc to generate an electrical signal; a DSP coupled to the pickup head, for receiving the electrical signal from the pickup head and generating an LDC block and a BIS block according to the electrical signal; a buffer memory; a decoder coupled to the DSP and the buffer memory, for receiving the LDC block and the BIS block from the DSP, generating user data according to the LDC block, generating control data according to the BIS block, and storing the user data and the control data into the buffer memory; and a control unit coupled to the decoder, for controlling the operation of the decoder.

The embodiments disclose a decoder set in an optical disc drive. The decoder is coupled to a buffer memory of the optical disc drive. The decoder comprises: a first interface coupled to the buffer memory, for receiving an LDC block that is generated by the optical disc drive through reading a blu-ray disc, and storing the LDC block into the buffer memory; a first processing unit coupled to the buffer memory, for receiving a BIS block that is generated by the optical disc drive through reading the blu-ray disc, generating a control data according to the BIS block, and storing the control data into the buffer memory; a second processing unit coupled to the buffer memory, for fetching the LDC block from the buffer memory, generating a user data according to the LDC block, and storing the user data into the buffer memory; and a host interface coupled to the buffer memory and a host device that is external to the optical disc drive, for fetching at least the user data from the buffer memory, and sending the user data to the host device.

The embodiments disclose a decoder set in an optical disc drive. The decoder is coupled to a buffer memory of the optical disc drive. The decoder comprises: a first interface coupled to the buffer memory, for receiving an LDC block that is generated by the optical disc drive through reading a blu-ray disc, and storing the LDC block into the buffer memory; a second interface coupled to the buffer memory, for receiving a BIS block that is generated by the optical disc drive through reading the blu-ray disc, and storing the BIS block into the buffer memory; a processing unit coupled to the buffer memory, for fetching the LDC block and the BIS block from the buffer memory, generating user data and control data according to the LDC block and the BIS block respectively, and storing the user data and the control data into the buffer memory; and a host interface coupled to the buffer memory and a host device that is external to the optical disc drive, for fetching at least the user data from the buffer memory, and sending the user data to the host device.

The embodiments disclose an optical disc drive for accessing a blu-ray disc. The optical disc drive comprises: a pickup head for reading data stored in the blu-ray disc to generate an electrical signal; a DSP coupled to the pickup head, for receiving the electrical signal from the pickup head, and generating an LDC block and a BIS block according to the electrical signal; a decoder coupled to the DSP and the buffer memory, for receiving the LDC block and the BIS block from the DSP, generating user data according to the LDC block, and generating control data according to the BIS block; and a control unit coupled to the decoder, for controlling the operation of the decoder, wherein the control unit does not receive or transmit the control data.

### BRIEF DESCRIPTION OF THE DRAWINGS

FIG. 1 shows the data format of blu-ray discs.

FIG. 2 shows an optical disc drive of the related art.

FIG. 3 shows an optical disc drive according to a first embodiment.

FIG. 4 shows an optical disc drive according to a second embodiment.

FIG. 5 shows an optical disc drive according to a third embodiment.

FIG. 6 shows an optical disc drive according to a fourth embodiment.

### DETAILED DESCRIPTION

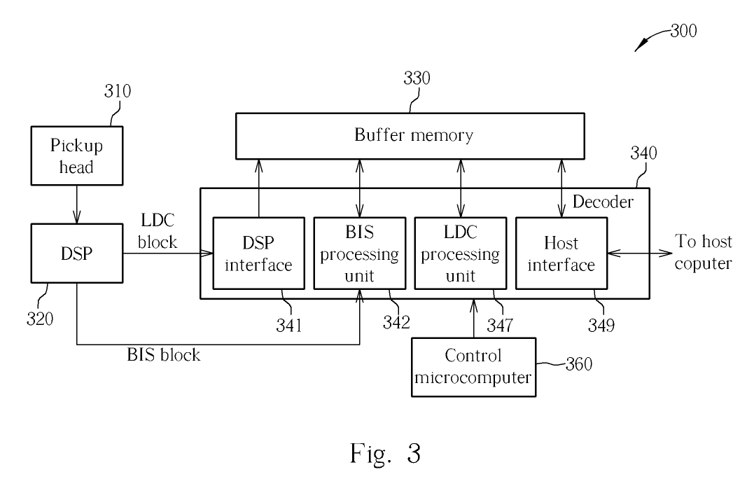

FIG. 3 shows an optical disc drive according to a first embodiment. The optical disc drive 300 shown in FIG. 3 comprises a pickup head 310, a digital signal processor (DSP) 320, a buffer memory 330, a decoder 340, and a control unit 360. In this embodiment a control microprocessor implements the control unit 360. A random access memory can be used to implement the buffer memory 330, which provides memory space required by the decoder 340. The pickup head 310 reads data stored in a blu-ray disc to generate an electrical signal and sends the electrical signal to the DSP 320. The DSP 320 processes the electrical signal to generate LDC blocks and BIS blocks, and sends the LDC blocks and the BIS blocks to the decoder 340. The control microprocessor 360 controls the operation of the decoder 340.

The decoder 340 comprises a first interface 341, a first processing unit 342, a second processing unit 347, and a host interface 349. In this embodiment, a DSP interface, a BIS processing unit, and an LDC processing unit serve as examples of the first interface 341, the first processing unit 342, and the second processing unit 347 respectively. The DSP interface 341 receives the LDC blocks from the DSP 320, and stores the LDC blocks into the buffer memory 330. The DSP interface 341 also examines synchronization conditions of the received signal to generate a system clock. According to the system clock, operational timing of each component can be determined. The BIS processing unit 342 receives the BIS blocks from the DSP 320, processes (e.g. error corrects) the BIS blocks to generate resulting control data, and stores the control data into the buffer memory 330. The LDC processing unit 347 fetches the LDC blocks from the buffer memory 330, processes (e.g. error corrects) the LDC blocks to generate resulting user data, and stores the user data into the buffer memory 330. The host interface 349 fetches the control data and the user data, which have already been error corrected by the BIS processing unit 342 and the LDC processing unit 347 respectively, from the buffer memory 330 and sends the control data or the user data to a host device (not shown in FIG. 3).

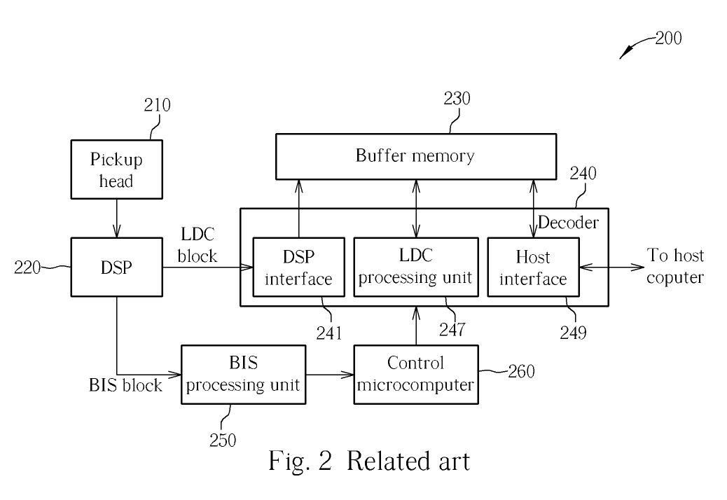

In this embodiment, the circuitry for processing the BIS blocks is included in the decoder 340. In other words, the decoder 340 includes the BIS processing unit 342 that processes the BIS blocks. Therefore, the control data generated by the decoder 340 can be sent to the host device through the host interface 349, without passing through the control microprocessor 360. Since the control microprocessor 360 in this embodiment is not responsible for receiving or transmitting the control data, data throughput of the control microprocessor 360 is preserved. Even under high-speed operations, the control microprocessor 360 of this embodiment will still have satisfactory decoding-control ability. The user data generated by the LDC processing unit 347 is stored in the buffer memory 330, which is also used to store the control data generated by the BIS processing unit 342. This characteristic makes the optical disc drive 300 shown in FIG. 3 differ further from the optical disc drive 200 shown in FIG. 2. More specifically, in FIG. 2, the user data generated by the LDC processing unit 247 is stored in the buffer memory 230; however, the control data generated by the BIS processing unit 250 is sent to the control microprocessor 260 directly and then sent out by the control microprocessor 260. In other words, the control data will not be stored into the buffer memory 230.

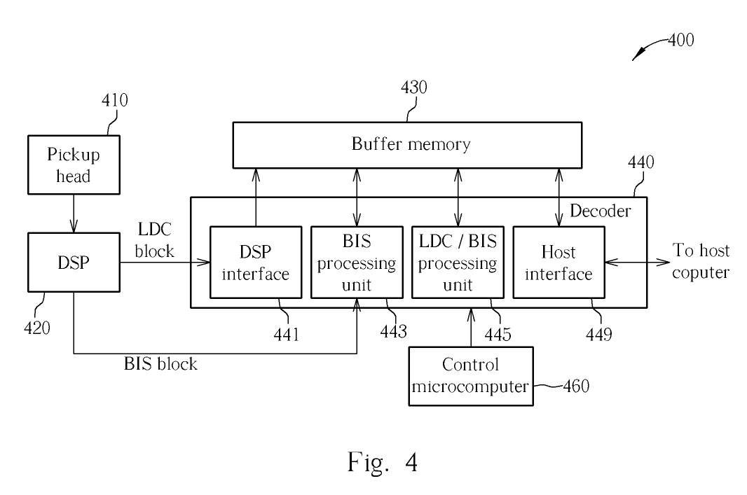

Please refer to FIG. 4, which shows an optical disc drive according to a second embodiment. The interior components of the optical disc drive 400 shown in FIG. 4 are similar to the interior components of the optical disc drive 300 shown in FIG. 3. More specifically, the optical disc drive 400 comprises a pickup head 410, a DSP 420, a buffer memory 430, and a control unit 460, which are similar to the pickup head 310, the DSP 320, the buffer memory 330, and the control microprocessor 360 respectively shown in FIG. 3. Herein the control unit 460 is also implemented by a control microprocessor. In addition, a first interface 441 and a host interface 449 set in a decoder 440 are similar to the DSP interface 341 and the host interface 349 respectively of the decoder 340. Herein the first interface 441 is also implemented by a DSP interface. Further descriptions of the above-mentioned interior components of the optical disc drive 400 are therefore omitted.

Aside from the DSP interface 441 and the host interface 449, the decoder 440 further comprises a second interface 443 and a LDC/BIS processing unit 445. The second interface 443 and the LDC/BIS processing unit 445 are implemented by a BIS interface and an LDC/BIS processing unit respectively. The BIS interface 443 receives the BIS blocks from the DSP 420, and stores the BIS blocks into the buffer memory 430. The LDC/BIS processing unit 445 fetches the LDC blocks and the BIS blocks, which are stored by the DSP interface 441 and the BIS interface 443 respectively, from the buffer memory 430. The LDC/BIS processing unit 445 then processes (e.g. error corrects) the LDC blocks to generate resulting user data, processes (e.g. error corrects) the BIS blocks to generate resulting control data, and stores the error corrected user data and control data into the buffer memory 430.

Aside from the advantages also present in the optical disc drive 300, the optical disc drive 400 has another additional advantage: only one error correction circuit, which is the LDC/BIS processing unit 445, is required by the decoder 440 to process the LDC blocks and BIS blocks stored in the buffer memory 430. Therefore, the structure of the decoder 440 is simpler than that of the decoder 340.

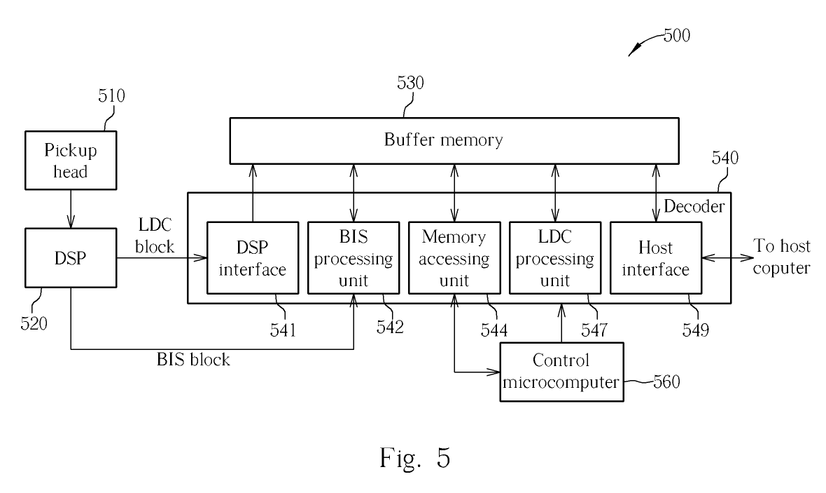

Please refer to FIG. 5, which shows an optical disc drive according to a third embodiment. The interior components of the optical disc drive 500 shown in FIG. 5 are similar to the interior components of the optical disc drive 300 shown in FIG. 3. More specifically, the optical disc drive 500 comprises a pickup head 510, a DSP 520, and a buffer memory 530, which are similar to the pickup head 310, the DSP 320, and the buffer memory 330 respectively shown in FIG. 3. In addition, a first interface 541, a first processing unit 542, and a second processing init 547 of a decoder 540 are similar to the DSP interface 341, the BIS processing unit 342, and the LDC processing unit 374 respectively of the decoder 340. Herein a DSP interface implements the first interface 541, a BIS processing unit implements the first processing unit 542, and an LDC processing unit implements the second processing unit 547. Further descriptions of the above-mentioned interior components of the optical disc drive 500 are therefore omitted.

Aside from the DSP interface 541, the first processing unit 542, and the second processing unit 547, the decoder 540 further comprises a memory accessing unit 544 and a host interface 549. The host interface 549 fetches the user data, which is stored by the LDC processing unit 547, from the buffer memory 530, and sends the user data to a host device (not shown). The memory accessing unit 544 fetches the control data, which is stored by the BIS processing unit 542, from the buffer memory 530, and sends the control data to a control unit 560. In this embodiment the control unit 560 is a control microprocessor, which controls the operation of the decoder 540. The control microprocessor 560 can send out the received control data, or use the control data fetched by the memory accessing unit 544 to improve the control flow of the control microprocessor 560, or store the information corresponding to the control data into the buffer memory 530. Since the control data generated by the BIS processing unit 542 is stored in the buffer memory 530, if it is required (e.g. when the control microprocessor 560 is busy performing control operations), the host interface 549 can also take the responsibility of fetching the control data from the buffer memory 530 and send the control data or information corresponding to the control microprocessor 560 to the host device. One of the advantages of the optical disc drive 500 is that, not only can the host interface 549 send out the control data, but the control microprocessor 560 can also take the responsibility of sending out the control data. The decoding process in this embodiment is therefore very flexible.

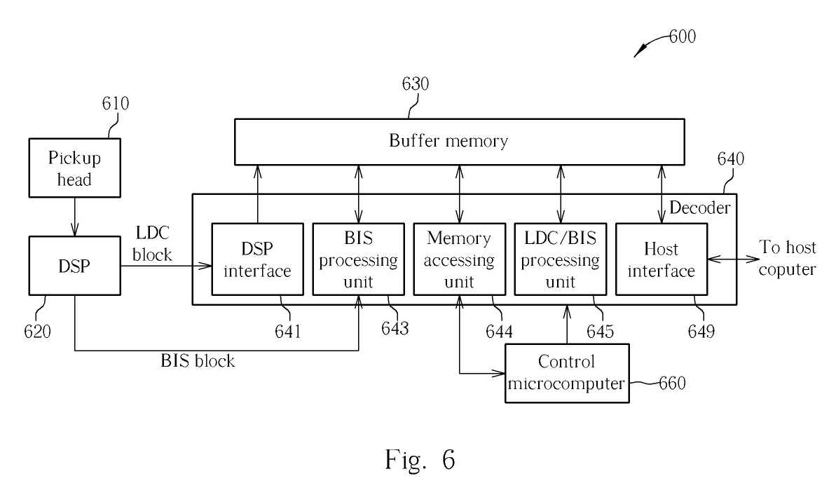

Please refer to FIG. 6, which shows an optical disc drive according to a fourth embodiment. The interior components of the optical disc drive 600 shown in FIG. 6 are similar to the interior components of the optical disc drive 500 shown in FIG. 5. More specifically, the optical disc drive 600 comprises a pickup head 610, a DSP 620, a buffer memory 630, and a control unit 660, which are similar to the pickup head 510, the DSP 520, the buffer memory 530, and the control microprocessor 560 respectively, shown in FIG. 5. Herein a control microprocessor implements the control unit 660. In addition, a first interface 641, a memory accessing unit 644, and a host interface 649 of a decoder 640 are similar to the DSP interface 541, the memory accessing unit 544, and the host interface 549 respectively of the decoder 540. Herein a DSP interface implements the first interface 641. Further descriptions of the above-mentioned interior components of the optical disc drive 600 are therefore omitted.

Aside from the DSP interface 641, the memory accessing unit 644, and the host interface 649, the decoder 640 further comprises a second interface 643 and a processing unit 645. In this embodiment a BIS interface and an LDC/BIS processing unit implement the second interface 643 and the processing unit 645 respectively. The BIS interface 643 receives the BIS blocks from the DSP 620 and stores the BIS blocks into the buffer memory 630. The LDC/BIS processing unit 645 fetches the LDC blocks and the BIS blocks from the buffer memory 630, where the LDC blocks and the BIS blocks are stored by the DSP interface 641 and the BIS interface 643 respectively, then processes (e.g. error corrects) the LDC blocks to generate resulting user data, processes (e.g. error corrects) the BIS blocks to generate resulting control data, and stores the user data and the control data into the buffer memory 630.

Apart from the advantages present in the optical disc drive 500, the optical disc drive 600 has an additional advantage. Specifically, only one error-correcting circuit, i.e. the LDC/BIS processing unit 645, is required by the decoder 640 to process the LDC blocks and the BIS blocks stored in the buffer memory 630. Therefore, the structure of the decoder 640 is simpler than that of the decoder 540.

With unspecified applications, a predetermined value “00h” can be used as the control data. Under such circumstances, the decoder in each embodiment can directly send the predetermined value “00h” out as the control data, hence omitting BIS related decoding process.

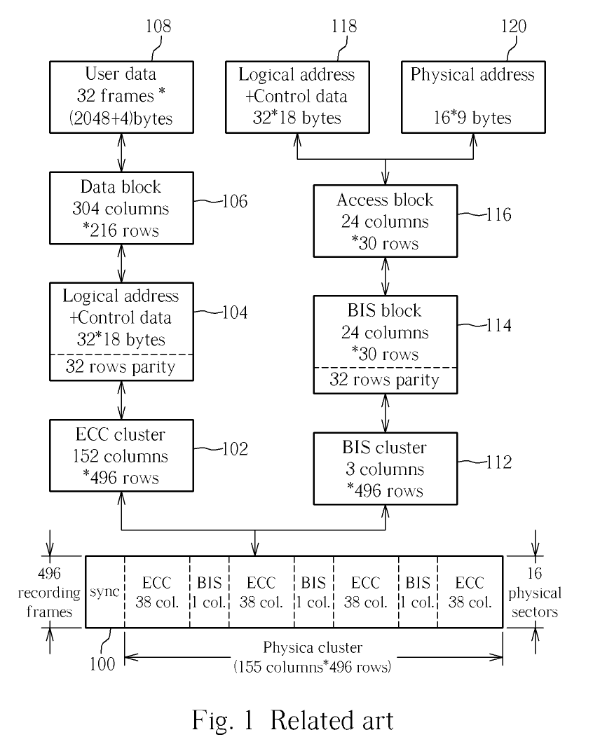

As shown in FIG. 1, decoding the BIS blocks enables the generation of not only the control data, but also the generation of other related address information, such as logical addresses and physical addresses. In each of the embodiments these logical addresses and physical addresses are also stored in the buffer memory. If it is required, these logical addresses and physical addresses generated through decoding the BIS blocks can be transmitted in a similar way to the control data.

What is claimed is:

1. An electronic device in an optical disc drive for accessing a blu-ray disc, the optical disc drive comprising a buffer memory and a pickup head for reading data stored in the blu-ray disc to generate an electrical signal, the electronic device comprising:
a DSP coupled to the pickup head, for receiving the electrical signal from the pickup head and generating a LDC block and a BIS block according to the electrical signal;
a decoder coupled to the DSP and the buffer memory, for receiving the LDC block and the BIS block from the DSP, generating user data according to the LDC block, generating control data according to the BIS block, and storing the user data and the control data into the buffer memory; and
a control unit coupled to the decoder, for controlling the operation of the decoder.

2. The electronic device of claim 1, wherein the decoder is further coupled to a host device; and the decoder also fetches at least the user data and the control data from the buffer memory, and sends the user data and the control data to the host device.

3. The electronic device of claim 2, wherein the decoder comprises:
a first interface coupled to the DSP and the buffer memory, for receiving the LDC block from the DSP, and storing the LDC block into the buffer memory;
a first processing unit coupled to the DSP and the buffer memory, for receiving the BIS block from the DSP, generating the control data according to the BIS block, and storing the control data into the buffer memory;
a second processing unit coupled to the buffer memory, for fetching the LDC block from the buffer memory, generating the user data according to the LDC block, and storing the user data into the buffer memory; and
a host interface coupled to the buffer memory and the host device, for fetching the user data and the control data from the buffer memory, and sending the user data and the control data to the host device.

4. The electronic device of claim 2, wherein the decoder comprises:
a first interface coupled to the DSP and the buffer memory, for receiving the LDC block from the DSP, and storing the LDC block into the buffer memory;
a second interface coupled to the DSP and the buffer memory, for receiving the BIS block from the DSP, and storing the BIS block into the buffer memory;
a processing unit coupled to the buffer memory, for fetching the LDC block and the BIS block from the buffer memory, generating the user data and the control data according to the LDC block and the BIS block respectively, and storing the user data and the control data into the buffer memory; and
a host interface coupled to the buffer memory and the host device, for fetching the user data and the control data from the buffer memory, and sending the user data and the control data to the host device.

5. The electronic device of claim 2, wherein if not specified, the decoder sends a predetermined value to the host device as the control data.

6. The electronic device of claim 5, wherein the predetermined value is “00h”.

7. The electronic device of claim 1, wherein the decoder is further coupled to a host device that is external to the optical disc drive, the decoder fetches the user data from the buffer memory, sends the user data to the host device, fetches the control data from the buffer memory, and sends the control data to the control unit; and the control unit receives the control data and sends the control data to the host device.

8. The electronic device of claim 7, wherein the decoder comprises:
a first interface coupled to the DSP and the buffer memory, for receiving the LDC block from the DSP, and storing the LDC block into the buffer memory;
a first processing unit coupled to the DSP and the buffer memory, for receiving the BIS block from the DSP, generating the control data according to the BIS block, and storing the control data into the buffer memory;
a second processing unit coupled to the buffer memory, for fetching the LDC block from the buffer memory, generating the user data according to the LDC block, and storing the user data into the buffer memory;
a memory accessing unit coupled to the buffer memory and the control unit, for fetching the control data from the buffer memory, and sending the control data to the control unit; and
a host interface, coupled to the buffer memory and the host device, for fetching the user data from the buffer memory, and sending the user data to the host device.

9. The electronic device of claim 7, wherein the decoder comprises:
a first interface coupled to the DSP and the buffer memory, for receiving the LDC block from the DSP, and storing the LDC block into the buffer memory;
a second interface coupled to the DSP and the buffer memory, for receiving the BIS block from the DSP, and storing the BIS block into the buffer memory;
a processing unit coupled to the buffer memory, for fetching the LDC block and the BIS block from the buffer memory, generating the user data and the control data according to the LDC block and the BIS block, and storing the user data and the control data into the buffer memory;
a memory accessing unit coupled to the buffer memory and the control unit, for fetching the control data from the buffer memory, and sending the control data to the control unit; and
a host interface coupled to the buffer memory and the host device, for fetching the user data from the buffer memory, and sending the user data to the host device.

10. The electronic device of claim 7, wherein if not specified, the decoder sends a predetermined value to the control unit as the control data.

11. The electronic device of claim 10, wherein the predetermined value is “00h”.

12. A decoder set in an optical disc drive, the decoder being coupled to a buffer memory of the optical disc drive, the decoder comprising:
a first interface coupled to the buffer memory, for receiving an LDC block that is generated by the optical disc drive through reading a blu-ray disc, and storing the LDC block into the buffer memory;
a first processing unit coupled to the buffer memory, for receiving a BIS block that is generated by the optical disc drive through reading the blu-ray disc, generating a control data according to the BIS block, and storing the control data into the buffer memory;
a second processing unit coupled to the buffer memory, for fetching the LDC block from the buffer memory, generating a user data according to the LDC block, and storing the user data into the buffer memory; and
a host interface coupled to the buffer memory and a host device, for fetching at least the user data from the buffer memory, and sending the user data to the host device.

13. The decoder of claim 12, wherein the host interface further fetches the control data from the buffer memory, and sends the control data to the host device.

14. The decoder of claim 13, wherein if not specified, the decoder sends a predetermined value to the host device as the control data.

15. The decoder of claim 14, wherein the predetermined value is “00h”.

16. The decoder of claim 12, wherein the decoder is further coupled to a control unit, the control unit controls the operation of the decoder, and the decoder further comprises:
a memory accessing unit coupled to the buffer memory and the control unit, for fetching the control data from the buffer memory, and sending the control data to the control unit.

17. The decoder of claim 16, wherein if not specified, the decoder sends a predetermined value to the control unit as the control data.

18. The decoder of claim 17, wherein the predetermined value is “00h”.

19. A decoder set in an optical disc drive, the decoder being coupled to a buffer memory of the optical disc drive, the decoder comprising:
a first interface coupled to the buffer memory, for receiving an LDC block that is generated by the optical disc drive through reading a blu-ray disc, and storing the LDC block into the buffer memory;
a second interface coupled to the buffer memory, for receiving a BIS block that is generated by the optical disc drive through reading the blu-ray disc, and storing the BIS block into the buffer memory;
a processing unit coupled to the buffer memory, for fetching the LDC block and the BIS block from the buffer memory, generating user data and control data according to the LDC block and the BIS block respectively, and storing the user data and the control data into the buffer memory; and
a host interface coupled to the buffer memory and a host device, for fetching at least the user data from the buffer memory, and sending the user data to the host device.

20. The decoder of claim 19, wherein the host interface further fetches the control data from the buffer memory, and sends the control data to the host device.

21. The decoder of claim 20, wherein if not specified, the decoder sends a predetermined value to the host device as the control data.

22. The decoder of claim 21, wherein the predetermined value is “00h”.

23. The decoder of claim 19, wherein the decoder is further coupled to a control unit, the control unit controls the operation of the decoder, and the decoder further comprises:
a memory accessing unit coupled to the buffer memory and the control unit, for fetching the control data from the buffer memory, and sending the control data to the control unit.

24. The decoder of claim 23, wherein if not specified, the decoder directly sends a predetermined value to the control unit as the control data.

25. The decoder of claim 24, wherein the predetermined value is “00h”.

26. An optical disc drive for accessing a blu-ray disc, the optical disc drive comprising:
a pickup head for reading data stored in the blu-ray disc to generate an electrical signal;
a DSP coupled to the pickup head, for receiving the electrical signal from the pickup head, and generating an LDC block and a BIS block according to the electrical signal;
a decoder coupled to the DSP and the buffer memory, for receiving the LDC block and the BIS block from the DSP, generating user data according to the LDC block, and generating control data according to the BIS block; and
a control unit coupled to the decoder, for controlling the operation of the decoder, wherein the control unit does not receive or transmit the control data.

27. The optical disc drive of claim 26, wherein the decoder is further coupled to a host device; and the decoder also sends at least the user data and the control data to the host device.

28. The optical disc drive of claim 27 further comprising a buffer memory coupled to the decoder, where the decoder comprises:
a first interface coupled to the DSP and the buffer memory, for receiving the LDC block from the DSP, and storing the LDC block into the buffer memory;
a first processing unit coupled to the DSP and the buffer memory, for receiving the BIS block from the DSP, generating the control data according to the BIS block, and storing the control data into the buffer memory;
a second processing unit coupled to the buffer memory, for fetching the LDC block from the buffer memory, generating the user data according to the LDC block, and storing the user data into the buffer memory; and
a host interface coupled to the buffer memory and the host device, for fetching the user data and the control data from the buffer memory, and sending the user data and the control data to the host device.

29. The optical disc drive of claim 27 further comprising a buffer memory coupled to the decoder, where the decoder comprises:
a first interface coupled to the DSP and the buffer memory, for receiving the LDC block from the DSP, and storing the LDC block into the buffer memory;
a second interface coupled to the DSP and the buffer memory, for receiving the BIS block from the DSP, and storing the BIS block into the buffer memory;
a processing unit coupled to the buffer memory, for fetching the LDC block and the BIS block from the buffer memory, generating the user data and the control data according to the LDC block and the BIS block respectively, and storing the user data and the control data into the buffer memory; and
a host interface coupled to the buffer memory and the host device, for fetching the user data and the control data from the buffer memory, and sending the user data and the control data to the host device.

30. The optical disc drive of claim 27, wherein if not specified, the decoder sends a predetermined value to the host device as the control data.

31. The optical disc drive of claim 30, wherein the predetermined value is “00h”.
